(19) United States
(12) Patent Application Publication
(10) Pub. No.: US 2009/0117416 A1
(43) Pub. Date: May 7, 2009

(54) End plates for fuel cell stack and method of manufacturing the same

(75) Inventor: Jung Do Suh, Seoul (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/006,159

(22) Filed: Dec. 31, 2007

(30) Foreign Application Priority Data
Nov. 5, 2007 (KR) 10-2007-0111877

(51) Int. Cl. H01M 8/02; B29C 39/02

(52) U.S. Cl. 429/12; 264/241

(57) ABSTRACT

The present invention provides an end plate for a fuel cell stack and a method of manufacturing the same, in which the end plate connected to each of both ends of a fuel cell stack is manufactured in a hybrid structure using two kinds of materials having different coefficients of thermal expansion, thus providing a uniform surface pressure in the fuel cell stack.

### CROSS-REFERENCE TO RELATED APPLICATION

This application claims under 35 U.S.C. §119(a) on Korean Patent Application No. 10-2007-0111877, filed on Nov. 5, 2007, the entire contents of which are incorporated herein by reference.

### BACKGROUND

(a) Technical Field

The present invention relates to an end plate for a fuel cell stack and a method of manufacturing the same. More particularly, the present invention relates to an end plate for a fuel cell stack and a method of manufacturing the same, in which the plate to be connected to each of both ends of a fuel cell stack is manufactured in a hybrid structure using two kinds of materials having different coefficients of thermal expansion, thus providing a uniform surface pressure in the fuel cell stack.

(b) Background Art

A polymer electrolyte membrane fuel cell (PEMFC) is a device that generates electricity with water produced as a result of an electrochemical reaction between hydrogen and oxygen. The PEMFC can be applied to various fields such as a zero-emission vehicle, an independent power plant, a portable military power source, and the like, due to its advantages such as higher fuel efficiency, higher current density, higher output density, shorter startup time, and faster response characteristics than other types of fuel cells.

Components of a fuel cell stack will be briefly described with reference to FIG. 1 below.

In the fuel cell stack, a membrane electrode assembly (MEA) 30 is positioned at the most inner portion, the MEA 30 including a solid polymer electrolyte membrane capable of transporting hydrogen protons, and catalyst layers, i.e., an anode and a cathode, formed on both ends of the electrolyte membrane to allow hydrogen and oxygen react with each other.

Moreover, a gas diffusion layer (GDL) 40 is positioned at the outside of the MEA 30, i.e., on the surface where the cathode and the anode are positioned, a separator having flow fields for supplying fuel and exhausting water produced by the reaction is positioned at the outside of the GDL, and an end plate 100 formed of a metal material is positioned at the most outside to support the respective components.

An oxidation reaction of hydrogen occurs at the anode of the fuel cell to produce hydrogen ions (protons) and electrons. The thus produced hydrogen ions and electrons are transferred to the cathode through the polymer electrolyte membrane and a conducting wire, respectively.

At the same time, a reduction reaction of oxygen occurs at the cathode receiving the hydrogen ions and electrons from the anode to produce water. Here, electrical energy is generated by the flow of the electrons through the conducting wire and by the flow of the protons through the polymer electrolyte membrane.

In such a fuel cell stack, the end plate 100 functions to support the respective components to provide a uniform surface pressure in the fuel cell stack. Providing a uniform surface pressure is a significant factor in preventing leakage of fluid in the stack and reducing electrical contact resistance between fuel cells, thus determining the performance of the fuel cell stack.

Conventionally, as shown in FIG. 2, end plates disposed at both ends of a fuel cell stack are connected to the fuel cell stack using a long bolt 50 or, as shown in FIG. 3, end plates disposed at both ends of a fuel cell stack are connected thereto using a strip 60.

However, the conventional methods of connecting the end plates have the following drawbacks.

The end plates are connected to both ends of the fuel cell stack by applying a clamping force of about 3000 to 4000 kgf to prevent fluid leakage of the fuel cell stack. Accordingly, as shown in FIG. 4, the middle portion of the end plate maintaining a horizontal state before deformation gets loose by elastic deformation.

That is, as the middle portion of the end plate gets loose by the elastic deformation due to the clamping force, a higher surface pressure is applied to the edges adjacent to the clamping portion by the long bolt or the strip, and a lower surface pressure is applied to the middle portion of the end plate relatively far way from the clamping portion.

When the middle portion of the end plate gets loose, electrical contact resistance may be increased in the middle portion of the fuel cell stack, to which a lower surface pressure is applied, and fluid leakage may occur.

Taking this into consideration, as shown in FIG. 5, the inner surface of the end plate to be connected to both ends of the fuel cell stack is formed into a curved surface by NC machining such that the curved surface by NC machining may be turned into a flat surface during the elastic deformation. However, such a method has drawbacks in that the NC machining process requires high cost and it is very difficult to process the curved surface to fit the deformation region of the end plate.

Accordingly, it is necessary to provide end plates, of which inner surfaces coming in contact with separators of a fuel cell stack do not get loose after being connected to the fuel cell stack but maintain a flat surface state.

The information disclosed in this Background section is only for enhancement of understanding of the background of the invention and should not be taken as an acknowledgement or any form of suggestion that this information forms the prior art that is already known to a person skilled in the art.

### SUMMARY OF THE DISCLOSURE

Accordingly, the present invention has been made in an effort to solve the above-described drawbacks, and one of the objects of the present invention is to provide an end plate for a fuel cell stack and a method of manufacturing the same, in which the end plate to be connected to each of both ends of a fuel cell stack are manufactured in a hybrid structure using a composite base material and a plurality of steel reinforced materials having different coefficients of thermal expansion such that a bent deformation caused by the different coefficients of thermal expansion and an elastic deformation caused by the clamping force are cancelled by each other, thus maintaining a flat surface state.

In one aspect, the present invention provides an end plate for a fuel cell stack having a hybrid structure comprising a base material and a plurality of reinforced materials having different coefficients of thermal expansion such that a bent is formed in the end plate before being connected to a fuel cell stack and the bent is deformed into a flat surface after being connected to the fuel cell stack.

In a preferred embodiment, the base material is a composite base material and the reinforced materials are steel reinforced materials, the plurality of steel reinforced materials being provided inside the composite base material at regular intervals in the longitudinal direction of the composite base material.

Preferably, the composite base material has a coefficient of thermal expansion of 10 μm/m ° C. (based on GEP215 Glass Fabric, SK-Chemical in South Korea) and the steel reinforced materials have a coefficient of thermal expansion of 16.5 μm/m ° C. (based on SUS316L).

In another aspect, the present invention provides a method of manufacturing an end plate for a fuel cell stack comprising: inserting a plurality of steel reinforced materials into a composite base material and curing the composite base material and the plurality of steel reinforced materials in a mold at a temperature of about 125° C. to form the end plate with a flat surface; and drying the cured end plate at room temperature, approximately 25° C., to cause a bent on the end plate by the characteristics of the materials having different coefficient of thermal expansion of the composite base material and the steel reinforced materials.

Accordingly, the reinforced materials arranged asymmetrically with respect to the section of the end plate cause a bent deformation on the end plate by the difference between the manufacturing temperature and the operation temperature such that the end plate has a flat surface and maintains a uniform surface pressure in a state where an elastic deformation by the clamping force overlaps with a thermal deformation at the operation temperature.

### BRIEF DESCRIPTION OF THE DRAWINGS

FIG. 1 is a schematic diagram illustrating the configuration of a fuel cell stack;

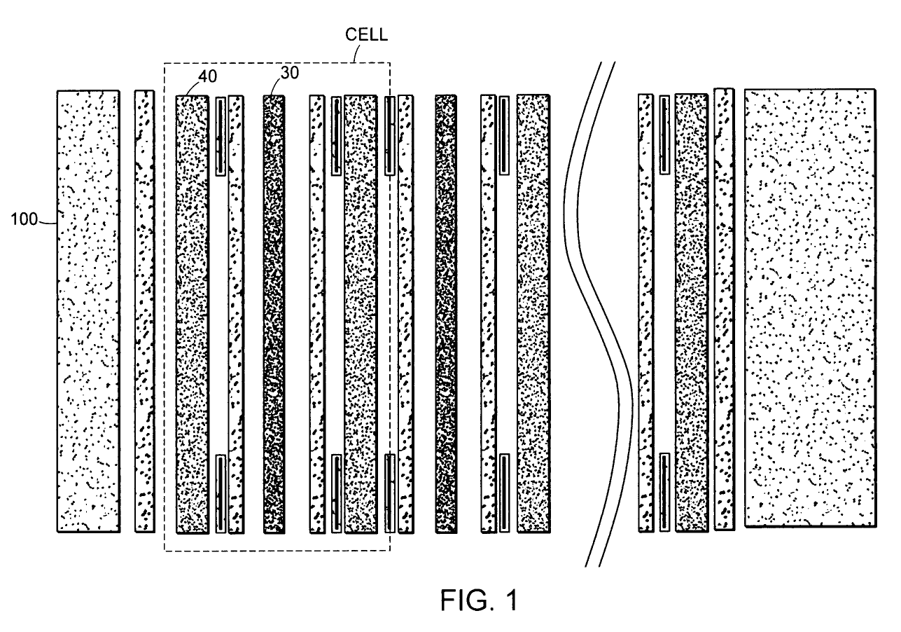

FIGS. 2 and 3 are schematic diagrams illustrating connection methods of end plates in conventional fuel cell stacks;

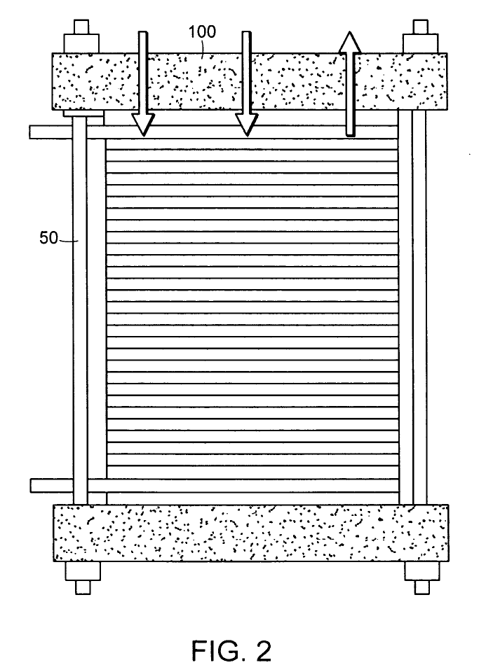

FIG. 4 is a schematic diagram illustrating elastic deformation according to clamping force of a conventional end plate;

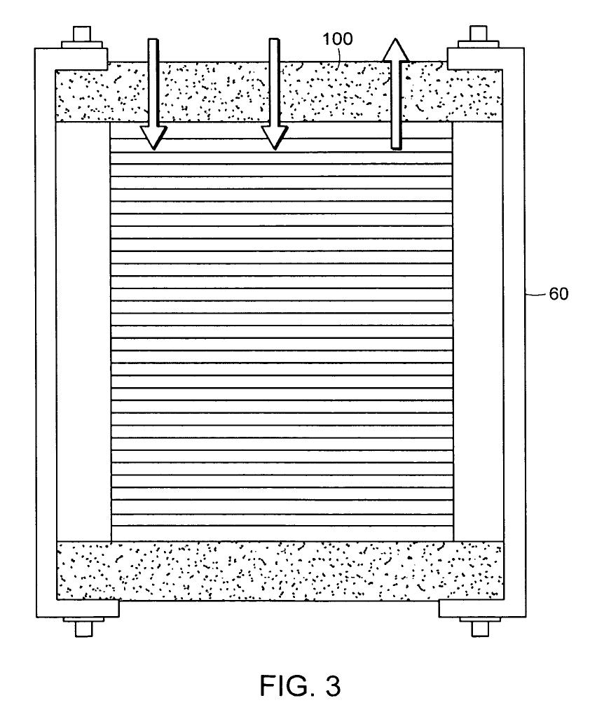

FIG. 5 is a schematic diagram illustrating an inner surface of the conventional end plate processed into a curved surface by NC machining in consideration of the elastic deformation of the end plate;

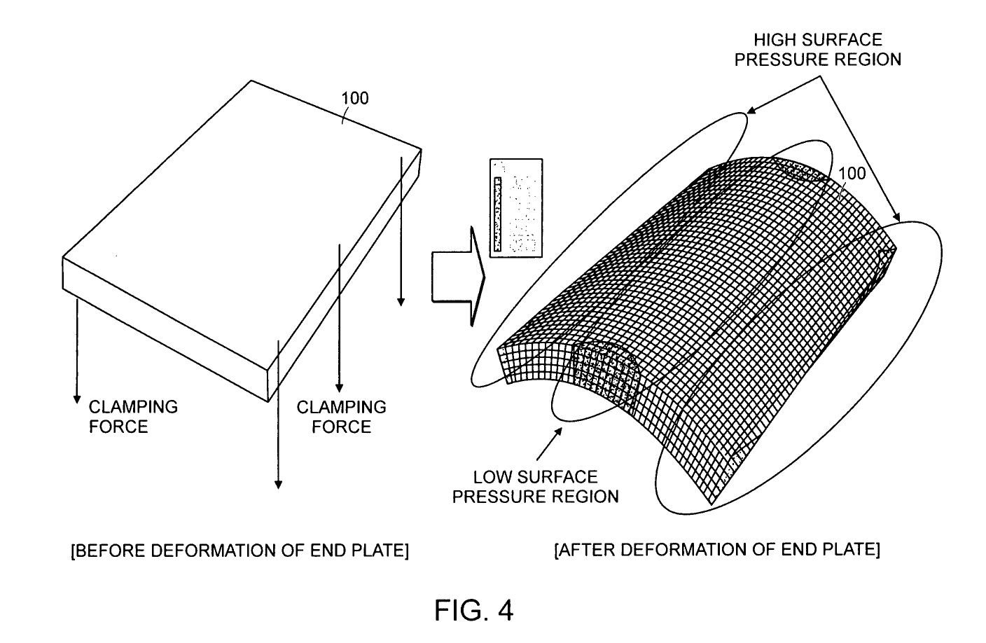

FIG. 6 is a perspective view illustrating the structure of an end plate in accordance with a preferred embodiment of the present invention;

FIG. 7 is a cross-sectional view illustrating the structure of the end plate in accordance with a preferred embodiment of the present invention; and

FIG. 8 is a cross-sectional view illustrating the operation of maintaining a flat surface state of the end plate in accordance with a preferred embodiment of the present invention.

Reference numerals set forth in the Drawings includes reference to the following elements as further discussed below:

| | |
|---|---|
| 10: composite base material | 20: steel reinforced material |
| 30: electrode membrane | 40: gas diffusion layer |
| 50: long bolt | 60: strip |
| 100: end plate | |

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

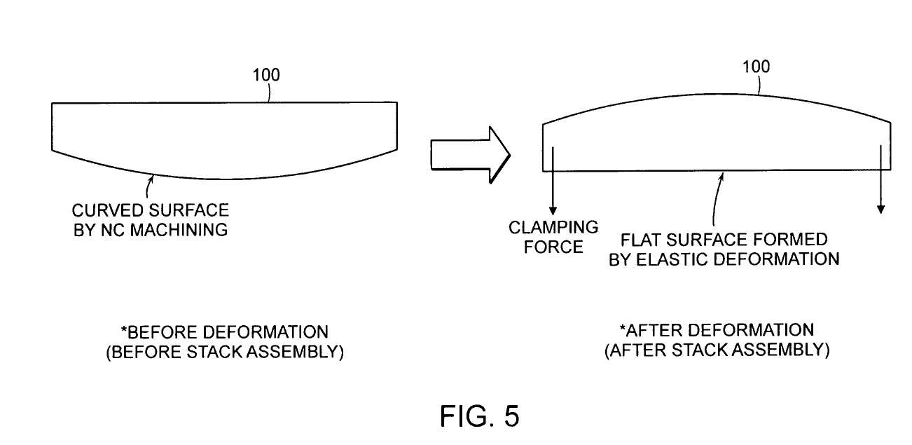

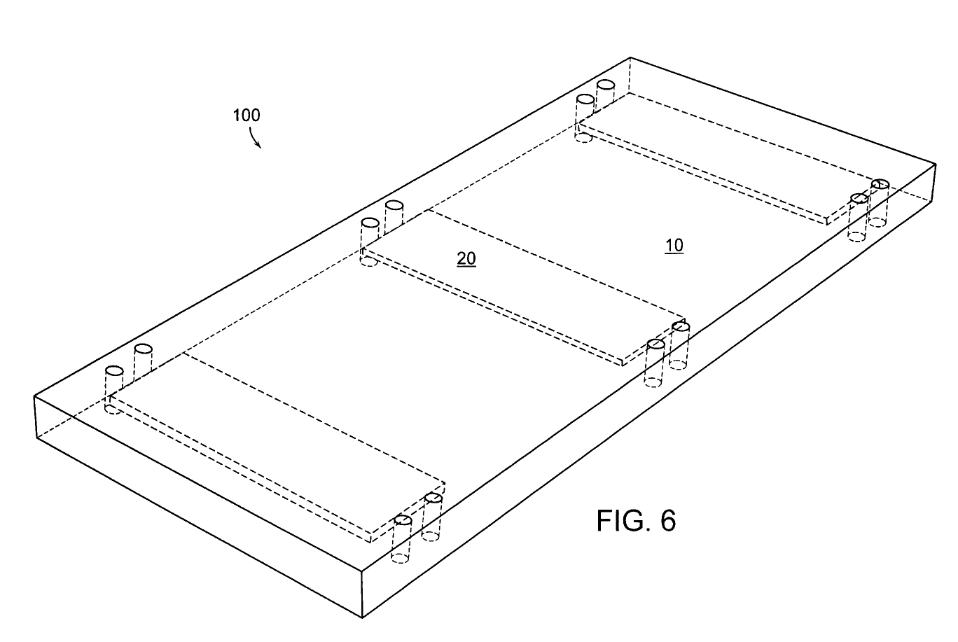

FIG. 6 is a perspective view illustrating the structure of an end plate in accordance with a preferred embodiment of the present invention, and FIG. 7 is a cross-sectional view illustrating the structure of the end plate in accordance with a preferred embodiment of the present invention.

The end plate 100 for a fuel cell stack in accordance with a preferred embodiment of the present invention is composed of a base material 10 and a plurality of reinforced materials 20 having different coefficients of thermal expansion such that, after the end plate 100 is connected to the fuel cell stack, the middle portion thereof is bent inwardly and the outer portion is bent outwardly due to the different coefficients of thermal expansion at room temperature, approximately 25° C.

In particular, the end plate 100 of the present invention is composed of a composite base material 10 of a predetermined area and a plurality of steel reinforced materials 20 provided inside the composite base material 10 at regular intervals in the longitudinal direction thereof. The composite base material 10 has a coefficient of thermal expansion of, for example, 10 μm/m ° C. and the steel reinforced materials 20 have a coefficient of thermal expansion of, for example, 16.5 μm/m ° C.

Of course, the composite base material 10 and the steel reinforced materials 20 may be selected from various materials used for manufacturing the fuel cell stack, and the present invention is not limited to a particular material, as long as they have different coefficients of thermal expansion.

The method of manufacturing the end plate of the present invention will be described in detail as follows.

The end plate 100 of the present invention 100 is manufactured by simultaneously curing the composite base material 10 and the steel reinforced materials 20 inserted in the composite base material 10 at a temperature of about 125° C.

First, the composite base material 10 is prepreg laminated and the plurality of steel reinforced materials 20 are inserted therein. Then, the composite base material 10 and the steel reinforced materials are cured at a temperature of about 125° C. to form a flat surface and dried at room temperature, approximately 25° C.

When the hybrid type end plate 100 composed of the composite base material 10 and the steel reinforced materials cured at high temperature is dried at the room temperature, approximately 25° C., a bent is formed according to the characteristics of the materials having different coefficients of thermal expansion. In this case, it is possible to adjust the bent degree by selecting the positions of the steel reinforced materials or the kind of the composite base material.

The base material 10 and the reinforced materials may be selected from various materials such as polymer, composite base material, metal, and the like. Moreover, according to the kinds of the selected materials, it is possible to employ various manufacturing processes such as injection molding, press molding, reaction injection molding (RIM), resin transfer molding (RTM), and the like. However, the base material 10 and the reinforce material 20 should have different coefficients of thermal expansion and the selection and design of the material should be made in consideration of the difference between the manufacturing temperature and the operation temperature.

The operation in which the end plate of the present invention manufactured as described above maintains the flat surface state will be described below.

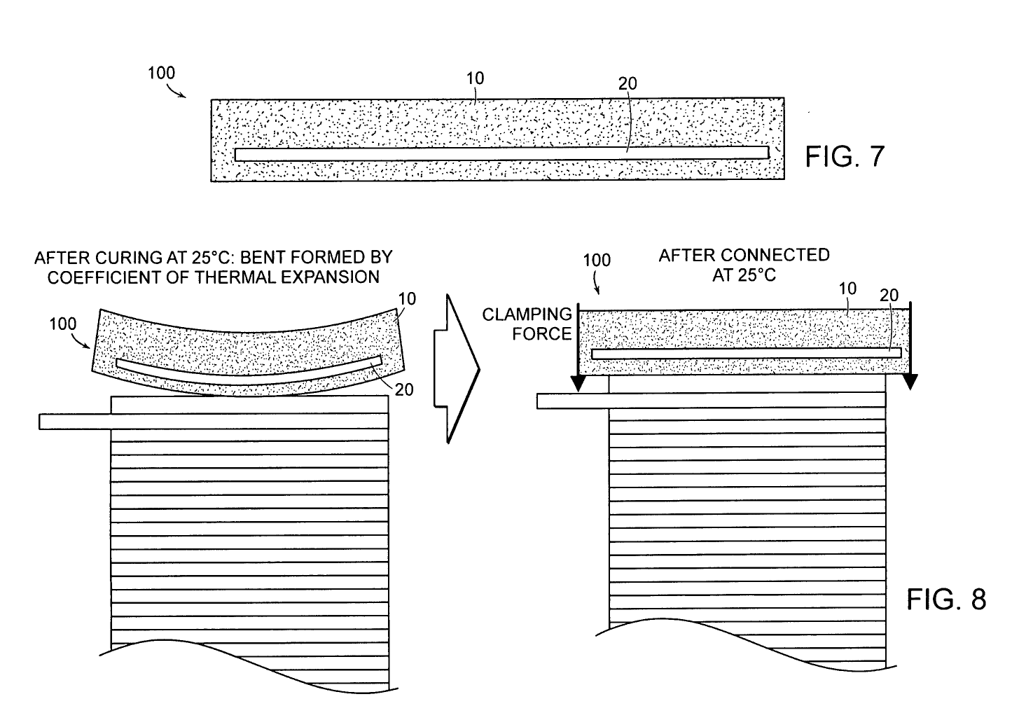

FIG. 8 is a cross-sectional view illustrating the operation of maintaining the flat surface state of the end plate in accordance with a preferred embodiment of the present invention.

The end plate 100 of the present invention, in which the plurality of steel reinforced materials 20 are provided inside the composite base material 10 in the longitudinal direction thereof, is connected to both ends of the fuel cell stack using a long bolt or stripe the same as the conventional one.

At this time, the end plates 100 are connected using a clamping force of about 3000 to 4000 kgf. Accordingly, the middle portion of the end plate 100 gets loose by elastic deformation and, at the same time, the middle portion is bent inwardly and the outer portion is bent outwardly at room temperature, approximately 25° C., due to the different coefficients of thermal expansion of the composite base material 10 and the steel reinforced materials 20, thus preventing the middle portion of the end plate 100 from getting loose by the elastic deformation.

As described above, according to the present invention, the end plates to be connected to both ends of the fuel cell stack are manufactured in a hybrid structure using the composite base material and the plurality of steel reinforced materials having different coefficients of thermal expansion such that a bent deformation caused by the different coefficients of thermal expansion and an elastic deformation caused by the clamping force are cancelled by each other, thus maintaining a flat surface state. Accordingly, it is possible to prevent fluid leakage in the fuel cell stack and reduce the electrical contact resistance between cells, thus maintaining the performance of the fuel cell stack.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An end plate for a fuel cell stack having a hybrid structure comprising a base material and a plurality of reinforced materials having different coefficients of thermal expansion such that a bent is formed in the end plate before the end plate is connected to a fuel cell stack and the bent is deformed into a flat surface after the end plate is connected to the fuel cell stack.

2. The end plate for a fuel cell stack of claim 1, wherein, the plurality of reinforced materials are provided inside the base material at regular intervals in the longitudinal direction of the base material.

3. The end plate for a fuel cell stack of claim 2, wherein the base material has a coefficient of thermal expansion of about 10 μm/m ° C. and the reinforced materials have a coefficient of thermal expansion of about 16.5 μm/m ° C.

4. A method of manufacturing an end plate for a fuel cell stack comprising:
inserting a plurality of reinforced materials into a base material and curing the base material and the plurality of reinforced materials in a mold to form the end plate with a flat surface; and
drying the cured end plate at room temperature to cause a bent on the end plate by the characteristics of the materials having different coefficients of thermal expansion of the base material and the reinforced materials.
